(19) United States
(12) Patent Application Publication
(10) Pub. No.: US 2006/0199162 A1
(43) Pub. Date: Sep. 7, 2006

(54) Universal audio device adaptor for books

(76) Inventors: Meg G. Clark, Roswell, GA (US); Gina G. Nobes, Roswell, GA (US)

Correspondence Address: Michael T. Cash, 11108 Eagle Trace Drive, New Market, MD, 21774, US

(21) Appl. No.: 11/074,348

(22) Filed: Mar. 4, 2005

(51) Int. Cl. G09B 5/00

(52) U.S. Cl. 434/308

(57) ABSTRACT

This invention is a universal adapter for attaching modern lightweight playback/recording devices to books. The invention (1) does not interfere with the traditional use of a book, (2) maintains lightweight and non invasive designs, (3) is safe, (4) can be adopted on books of all sizes, (5) provides for easy use of the playback/recording device while reading or looking at the book and is reusable in certain configurations. This invention accomplishes all of these goals in new and unexpected ways and results in a universal means of adapting playback/recording devices to books that far exceeds the capability of anything currently in the market. By focusing on the interface between the book and the playback/recording device these important goals can be achieved in unison in a novel way.

### BACKGROUND OF THE INVENTION

1. Field of the Invention

The use of recorded sound to accompany books has been in existence for a period of time. The recorded sound can be for many purposes, for example to assist children in learning to read, as general entertainment, to create a memorable experience for a friend or family member while looking through a book, or for infants use in learning new words or sounds. As electronic components have continued to shrink in size, devices which can record and playback sound have also grown smaller and smaller. This reduction in size has broadened the potential application of playback/recording devices for use with books.

Recorded sound (music, voice or other general sounds) was initially widely available in reel to reel or cassette tape (4″×2″) format. The supporting electronics for these formats ranged in size from that of a current desktop computer (reel to reel) to that of small portable radios (cassette tapes). These relatively large devices consisting of primarily analog circuits and electromechanical components for moving the recording media limited to a certain extent the adaptability of playback/recording devices for book applications. Starting in the mid 1990s digital electronics accelerated the micronization of electronics devices including playback/recording devices. Current playback/recording devices that use tape media (micro-cassettes) are widely available in sizes as small as a pack of cigarettes. In more recent times, devices have emerged that do not rely on removable recording media instead relying on digital storage of sound in “digital storage devices” directly in the playback/recording devices. These devices range in size from that of a pack of cigarette down to sizes nearly as small as a postage stamp (and will probably grow smaller).

The existence of wide ranging sizes for playback/recording devices increases the range of application of these devices for use with traditional books. Many existing applications present integrated packages relying on a specific selected format (size) of playback/recording device designed for a specific book size. This integrated approach reduces the flexibility of consumer choice in selecting books with audio playback/recording capability.

This invention seeks to provide greater flexibility in this regard by focusing on new and innovative means of coupling playback/recording devices to books in a manner that is adaptable to many forms of books and devices. In each of the embodiments, the book fully retains its “traditional use” while allowing for certain playback/recording devices to be directly integrated onto the back cover of a traditional book in innovative configurations and manners. In this invention, preservation of the “traditional use” of the book means: “the back cover and front cover can still be viewed in the entirety both inside and out. In addition, the pages of the book can be turned without interference from the playback/recording device. In addition, the invention will not interfere with normal opening or closure of the book and also not interfere with reading the book. The invention remains lightweight and unobtrusive in all embodiments allowing for ease of storage, use and transportation of the book. In addition, the ability to fully access the controls of the playback/recording device in an efficient manner while “reading” or “looking” at the book is maintained.”

2. Brief Description of Related Art

There are a number of patents in the related art involving playback/recording devices or systems integrated into books or albums. Some of the related art is directed to the underlying electronics or methods of recording and/or producing audio with books or albums. For example in Crowell (U.S. Pat. No. 5,387,108) the invention describes details of circuit board connections and various other devices to accomplish the playback/recording integral into a book or album. In a similar manner, Manico (U.S. Pat. No. 5,520,544), Padgett (U.S. Pat. No. 6,421,524) and Garrett (U.S. Pat. No. 6,591,526) provide descriptions of various concepts involving underlying circuitry, interconnection of components and integration of these components and circuits directly into the book. None of these patents describe means of attachment of standalone playback/recording devices to books. In this manner this related art does not offer the end user the flexible and wide ranging options as are available in this invention. This related art is directed to the end results of the invention in this application but does not address means of attaching standalone playback/recording devices of various designs to books and albums. Because of this focus this related art offers no flexibility to the user as to the type of playback/recording device or the book into which such a device would be integrated. The end user must use the configuration available in each design.

Four patents in the related art provide some focus on the attachment of a playback/recording device to books. However, in two of the cases Jacobson (U.S. Pat. No. 5,903,869) and Borcherding (U.S. Pat. No. 5,890,121) the patents focus on a wide range of surfaces and objects. In these patents, the potential use of the devices on books is an afterthought and the specific means of adaptation to a book is not described in any detail. These devices are more focused on something useful for a reminder system, a note system or a simple message system. As such applications for attachment to a computer, refrigerator or other means of digital messaging are described in these patents. In these examples, the usefulness of the playback/recording device and/or the “traditional use” of the books will be impaired, in contrast to the invention described in this application. In Skidmore (U.S. Pat. No. 5,277,452) the invention focuses on a means of attaching a relatively large tape recorder (cassette size) in a hardened “frame” configuration. This system is rather awkward and is only useful for recorders sized for the frame which is built into the book. The device also does not provide ready access to the recorder while reading or looking at the book. Finally Phinisee-Washington (U.S. Pat. No. 6,661,899) provides for a microphone, amplifier system with the microphone attached to the outer spine of the book and the electronics forced into the spine of the book where sufficient room exists for insertion of these electronics into the spine. There is no provision in this design for accessing playback/recording controls while reading or looking at the book since any such controls would be inside the spine of the book. It is also appears that the design only accommodates sound amplification, for example for reading to a group of children and does not provide any playback/recording capability.

### OBJECTS OF THE INVENTION

This invention focuses in particular on the optimal ways to connect modern lightweight playback/recording devices to books. The invention (1) does not interfere with the “traditional use” of a book, (2) maintains lightweight and non invasive designs, (3) is safe, (4) can be adapted on books of all sizes, (5) provides for easy use of the playback/recording device while reading or looking at the book and (6) is reusable in certain configurations.

This invention accomplishes all of these goals in new and unexpected ways and results in a universal means of adapting playback/recording devices to books that far exceeds the capability of anything currently in the market. By focusing on the interface between the book and the playback/recording device these important goals can be achieved in unison in a novel way.

### SUMMARY OF THE INVENTION

The invention involves novel means for attaching a lightweight playback/recording device to books in a manner that does not interfere with the traditional use of the book. The first embodiment involves two clear adhesive strips. The strips form a V-shape where the point of the V is attached or integrated onto the body of base plate. The open ends are attached to the back cover of the book, with one strip on the outside of the back cover and one strip on the inside of the back cover. The base plate then provides a platform for attaching various playback/recording devices of various sizes through various attachment means. In this manner, the playback/recording device will be accessible to the user beyond the outer edge of the back cover, typically with the controls facing front for use while reading or looking at the pages of the book. The base plate could be located at the top, bottom or outer edge of the book cover using the same V configuration.

Another, embodiment would be a clear plastic (other similar material) plate which would be attached to the back of the book with a portion of the plate extending beyond the outer edge of the book either on the side, top or bottom. The back of the playback/recording device would be attached to this extending edge in a range of options as for the base plate described above. This embodiment does not rely on the V strips described above.

In another embodiment, a number of clear rigid strips are sandwiched between the V shaped adhesive panels and the outer surface of the back cover. The point of the V would then come in direct contact with the outer edge of the back cover, either at the top, bottom or outer edge. The rigid strips would be sized and placed on the outer back cover so that a sufficient extension exists to provide a platform for a base plate or for direct connection of the strips to the playback/recording device described above. In this manner, the playback/recording device will be accessible to the user and is located beyond the outer edge of the back cover, typically with the controls facing front for use while reading or looking at the pages of the book.

In another embodiment, a number of clear rigid strips are directly connected (adhesive or mechanical) the back cover of the book. The rigid strips would be sized and placed on the outer back cover so that a sufficient extension exists to provide a platform for a base plate or for direct connection of the strips to the playback/recording device described above. In this manner, the playback/recording device will be accessible to the user and is located beyond the outer edge of the back cover, typically with the controls facing front for use while reading or looking at the pages of the book. This embodiment does not rely on the V strips described above.

In another embodiment a clear plastic (other similar material) plate would be attached to the back of the book without extending beyond the outer edge of the book in any direction. The clear plastic plate would have a recessed cavity along one edge, either top, outer edge or bottom. Within the cavity would be a base plate as described above. The base plate can we withdrawn and a recording/playback device attached through a variety of temporary means. The recording/playback device can be removed from the base plate and the base plate re-inserted into the recessed cavity after use or for storage of the book.

The foregoing is considered illustrative only of the principles of the invention. Further, since numerous modifications and changes will readily occur to those skilled in the art, it is not desired to limit the invention to the exact construction and operation shown and described, and accordingly, all suitable modifications and equivalents that may be resorted to fall within the scope of this invention.

### BRIEF DESCRIPTION OF THE DRAWINGS

FIG. 1 provides the general arrangement of the V clear clamp configuration where the playback/recording device is on the outer edge.

FIG. 2 provides the attachment details for adhesive connection between the playback/recording device and the base plate.

FIG. 3 provides the attachment details for mechanical connection between the playback/recording device and the base plate.

FIG. 4 provides the attachment details for slotted connection between the playback/recording device and the base plate.

FIG. 5 provides the attachment details for snap-in connection between the playback/recording device and the base plate.

FIG. 6 provides details on V clamp, book to base plate connections.

FIG. 7 provides a general arrangement perspective on the plate configuration with the playback/recording device located at the top of the book.

### DETAILED DESCRIPTION OF THE PRERRED EMBODIMENT

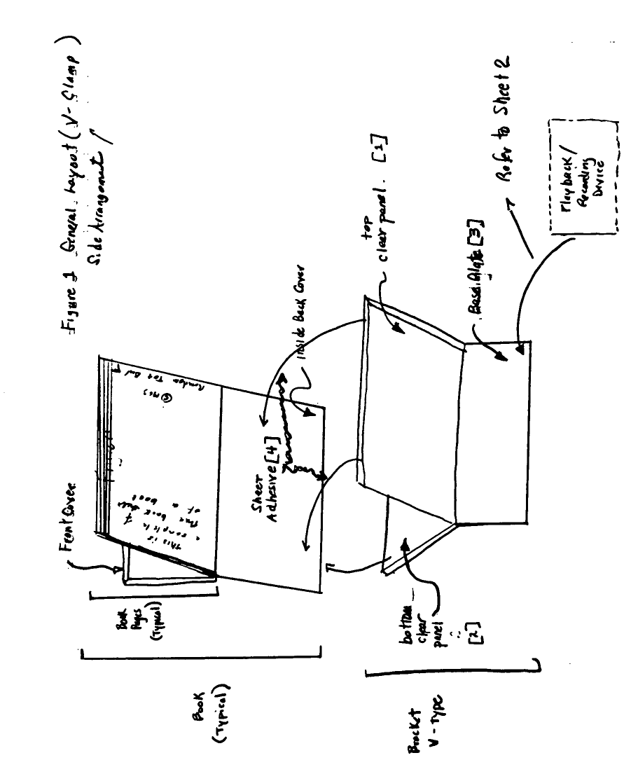

In the preferred embodiment, the top clear panel [1] and bottom clear panel [2] are configured in a V shape. One side of the top clear panel [1] will be attached via panel adhesive [4] to the inside of the back cover of a book. In similar fashion, one side of the bottom clear panel [2] will be attached via panel adhesive [4] to the outside of the back cover of a book. At the point where the two clear panels come together (point of the V) the panels will be attached to or integrated into the base plate [3]. As shown, in FIG. 1 the preferred embodiment has the base plate [3] located on the outer edge of the book cover. The preferred embodiment can be configured with the base plate [3] at either the top edge, bottom edge or outer edge of the back cover by locating the tip of the V to the appropriate edge.

In FIG. 1 the base plate [3] is shown to run the full length of the outer edge of the books back cover. Based on the size of the book and the desired playback/recording device base plate [3] may run along only part or the full length of the selected edge. In addition, the base plate [3] may run the length of the back cover but use some of the space for purposes other than mounting the playback/recording device (for example, information or decoration). In this manner, the playback/recording device will be accessible to the user beyond the outer edge of the back cover, typically with the controls facing front for use while reading or looking at the pages of the book.

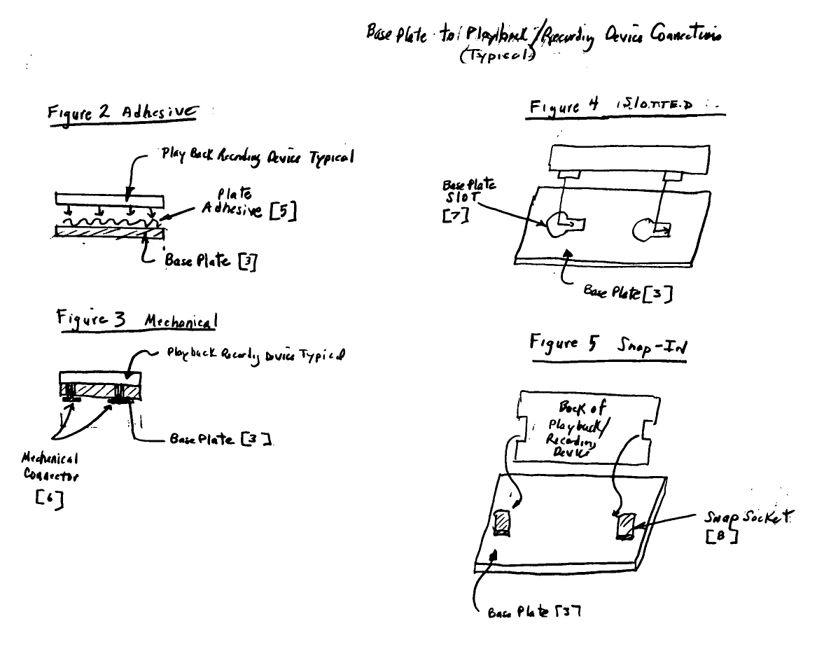

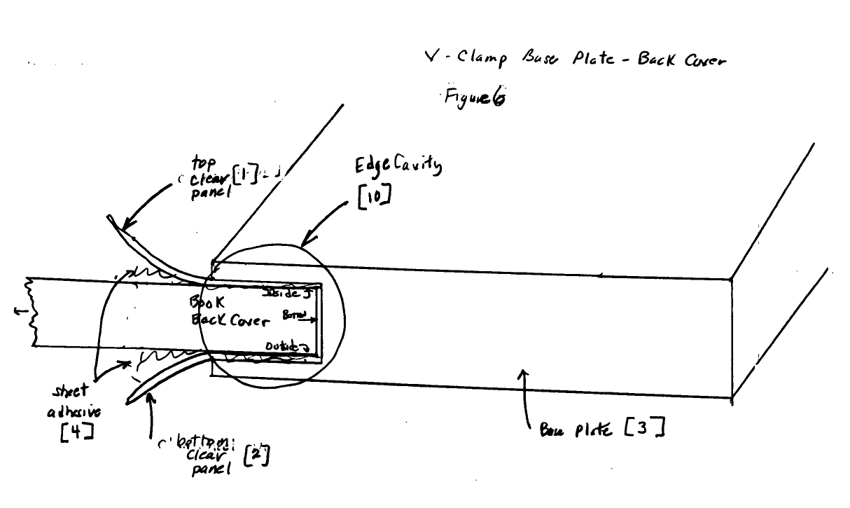

The playback/recording device can be attached to the base plate [3] through a wide range of means including adhesives, mechanical, slots or snaps. A number of versions of these connections are shown in FIGS. 2 through 5. In FIG. 2, a plate adhesive [5] is used between the back of the playback/recording device and the base plate [3]. In FIG. 3, the base plate [3] would have a number of holes through it with a number of mechanical connectors [6] (e.g. screws or rivets) passing through and into the back of the playback/recording device. In FIG. 4, a number of slots [7] in the base plate [3] would accommodate properly adapted pegs in the back of the playback/recording device. In FIG. 5, a number of male snap sockets [8] in the base plate [3] would accommodate properly adapted female snap sockets in the back of the playback/recording device.

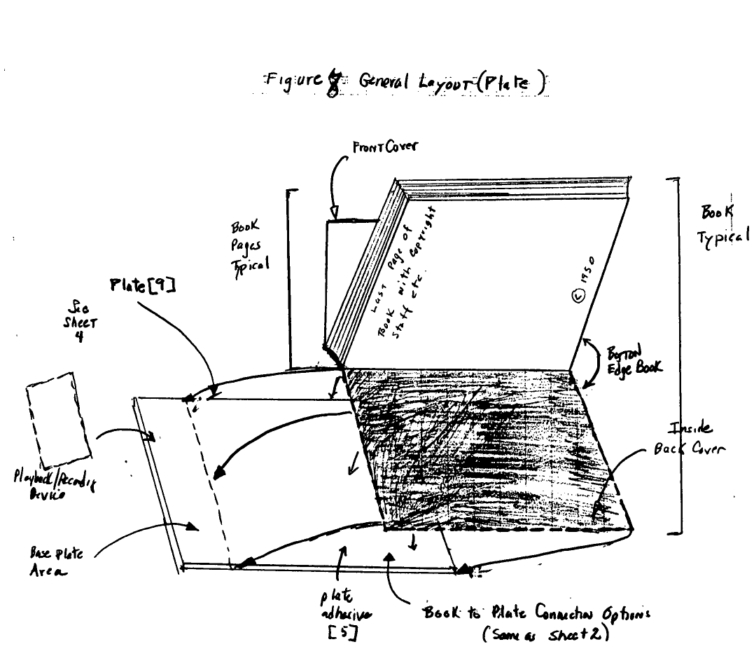

The connection between the point of the V for the top clear panel [1] and bottom clear panel [2] to the base plate [3] and the back cover of the book can be accomplished in a number of ways. One such configuration is demonstrated in FIG. 6, where each clear panel is sandwiched in a slot in the base plate [3] between the edges of the slot at the surfaces of the book cover. Adhesives would be included in the sandwich to provide for a more permanent connection.

The foregoing is considered illustrative only of the principles of the invention. Further, since numerous modifications and changes will readily occur to those skilled in the art, it is not desired to limit the invention to the exact construction and operation shown and described, and accordingly, all suitable modifications and equivalents that may be resorted to fall within the scope of this invention.

We claim:

1. An adapter comprising,
a. a base plate with an inner edge and an outer edge, a bottom surface and a top surface,
b. a top clear panel with an inner edge,
c. a bottom clear panel with an inner edge,
d. a sheet adhesive layer,
where the inner edge of said base plate is connected, by means of said sheet adhesive layer, to said inner edge of said top clear panel, and
where the inner edge of said base plate is connected, by means of said sheet adhesive layer, to said inner edge of said bottom clear panel, and
where the connections of said top clear panel and said bottom clear panel to said base plate are co-linear connections in direct or nearly direct contact along the length of said base plant inner edge.

2. The adapter of claim 1, further comprising,
a. a plate adhesive layer on said top surface of said base plate.

3. The adapter of claim 1, further comprising,
a. a number of openings included in said base plate, with said openings passing through said top surface through to said bottom surface of said base plate.

4. The adapter of claim 1, further comprising,
a. a number of slots included in said top surface of said base plate, where said slots have an upper end and a lower end, where said upper end is larger in diameter than said lower end.

5. An adapter comprising,
a. a base plate with an inner edge and an outer edge, a bottom surface, a top surface, and an edge cavity along the length of said inner edge,
b. a top clear panel with an inner edge,
c. a bottom clear panel with an inner edge,
d. a sheet adhesive layer,
where the inner edge of said base plate is connected, by means of said sheet adhesive layer, to said inner edge of said top clear panel, with said connection inside of said edge cavity, and
where the inner edge of said base plate is connected, by means of said sheet adhesive layer, to said inner edge of said bottom clear panel, with said connection inside of said edge cavity, and
where the connections of said top clear panel and said bottom clear panel to said base plate are co-linear connections in direct or nearly direct contact along the length of said base plant inner edge, inside of said edge cavity.

6. The adapter of claim 5, further comprising,
a. a plate adhesive layer on said top surface of said base plate.

7. The adapter of claim 5, further comprising,
a. a number of openings included in said base plate, with said openings passing through said top surface through to said bottom surface of said base plate.

8. The adapter of claim 5, further comprising,
A. a number of slots included in said top surface of said base plate, said slots have an upper end and a lower end, where said upper end is larger in diameter than said lower end.

9. An adapter comprising,
a. a clear plate with an inner edge and an outer edge, top edge, bottom edge, a bottom surface and top surface,
b. where said clear plate has a cavity along one edge, either the outer edge, top edge or bottom edge,
c. a base plate where said base plate fits completely within said cavity, with a means where said base plate can extend outward from the cavity while remaining firmly held co-planar to said clear plate.
